(19) United States
(12) Patent Application Publication
(10) Pub. No.: US 2015/0367716 A1
(43) Pub. Date: Dec. 24, 2015

(54) METHOD FOR INJECTION MOLDING END MUCKETS TO A PREVIOUSLY MOLDED VEHICLE PANEL AND PRIOR TO INSTALLATION OF A SEPARATELY EXTRUDED AND ELONGATED COMPRESSION SEAL

(71) Applicant: U.S. Farathane Corporation, Auburn Hills, MI (US)

(72) Inventors: Kevin Charles Baxter, Goodrich, MI (US); Stephen G. Leonard, Waterford, MI (US)

(21) Appl. No.: 14/838,606

(22) Filed: Aug. 28, 2015

Related U.S. Application Data
(62) Division of application No. 14/244,842, filed on Apr. 3, 2014.
(60) Provisional application No. 61/874,556, filed on Sep. 6, 2013.

(51) Int. Cl. B60J 10/00; B62D 25/08; B60J 10/02

(52) U.S. Cl. CPC B60J 10/0031; B60J 10/02; B60J 10/0062; B62D 25/081

(57) ABSTRACT

A seal for incorporating into a vehicle application, including an elongated body having a first softer portion exhibiting a multi-sided and enclosed cross sectional profile and a second more rigid portion coextruded with the softer portion and which is adapted to being resistively engaged with an extending location associated with a vehicle panel so that the first portion is supported upon the panel and adapted to being contacted by a further component associated with the vehicle. The first portion exhibits a multi-sided profile in cross section with a hollow interior to facilitate controlled and cushioning collapse when compressed and includes an upper portion having a generally conical pointed upper end and a pair of outwardly flared lower ends. A slip coat is applied over the body and includes any type of plastic olefinic based grade or post applied and cured material

### CROSS-REFERENCE TO RELATED APPLICATIONS

This Application is a Division of application Ser. No. 14/244,842 filed on Apr. 3, 2014. application Ser. No. 14/244,842 claims the benefit of U.S. Provisional Application 61/874,556 filed on Sep. 6, 2013.

### FIELD OF THE INVENTION

A coextruded or tri-extruded bulb seal which is constructed of at least one softer and one harder polymer material for various in-vehicle applications including, without limitation, along extending edge interfaces associated with the cowl to hood, rocker seal, grill seal, rear trunk and deck lid seals, lift gate seal, etc. The seal eliminates the need for a secondary molded attachment pin, as it is integrated into the part.

A cowl to hood seal variant depicts a tri-extruded variant, including a base attaching material exhibiting a more rigid filled or unfilled polypropylene, a polygonal and interiorly hollowed softer thermoplastic olefin, thermal plastic vulcanite, ethylene propylene diene monomer or the like, and an olefinic based slip coat which is coated or otherwise post applied and cured about the part and which provides a lowered coefficient of friction, such as during installation of the anchoring base material into a slot or channel associated with the mounting location. One application of the tri-extruded seal located between the cowl and glass also depicts the use of a snap-in assembly with overlap, this including integrated end muckets which conform to an edge profile of the vehicle fender.

### BACKGROUND OF THE INVENTION

The prior art is well documented with examples of composite extrusions having both thermoset and thermoplastic components. Among these are included the method for forming a composite extrusions in Cook, U.S. Pat. No. 5,686,165 and U.S. Pat. No. 5,411,785. In each instance, a main body portion is extruded from a thermosetting material, heated, and then coextruded with a second thermoplastics material, following which the co-extrusion is cooled and formed into its final shape.

Venkataswamy, U.S. Pat. No. 6,602,589, teaches an olefinic slip coating for automotive weatherseals. Other vehicle related seals include that depicted in Rood, U.S. Pat. No. 6,617,015, (and which depicts an upper flexible bulb shaped portion constructed of a softer thermoplastic foam in combination with an integrally formed base portion of polymeric material and configured with spaced apart and recess defining walls for fitting upon a support flange). Miyakawa, US 2011/0219699, teaches an extrusion molded product having a core material for mounting to a peripheral flange such as associated with a door, trunk, or the like and including a base portion 6, an outer coating layer 8 and an upper extending hollow seal portion 2 having any of a polygonal, circular, elliptical or other shape as required.

Harland, US 2010/0263292, teaches a multi-material layered weatherseal extrusion having a lip extending from one side of a body, the lip including a barrier layer and decorative layer. A core of the weatherseal can be broken and the second or decorative layer applied downstream of the first extrusion crosshead. The first and second layers are then applied in a second crosshead extrusion die.

A further class of weather strip seals are shown in each of Hashimoto, U.S. Pat. No. 6,848,217, Offenbacher, U.S. Pat. No. 4,143,497, Otsuka, US 2013/0067821, Kuwabra, US 2013/0160375 and Harland US 2010/0263292.

### SUMMARY OF THE INVENTION

The present invention discloses a seal for incorporation into a vehicle application, including an elongated body having a first softer portion exhibiting a multi-sided and enclosed cross sectional profile and a second more rigid portion coextruded with the softer portion and which is adapted to being resistively engaged with an extending location associated with a vehicle panel so that the first portion is supported upon the panel adapted to being contacted by a further component associated with the vehicle. The first portion further includes a multi-sided profile in cross section with a hollow interior in order to facilitate controlled and cushioning collapse when compressed and may also exhibit an upper portion having a generally conical pointed upper end and a pair of outwardly flared lower ends.

Additional features include a slip coat applied over at least one of the first and second portions of the elongated body and including any type of plastic olefinic based grade or post applied and cured material. The second portion has an elongated base material which includes an upper most planar shaped mounting ledge exhibiting a given width with opposite edges to which said lower ends of the first portion are co-extruded. A plurality of spaced apart and integrally projecting anchor portions project from a reverse side of the planar mounting ledge. Each of the anchor portions has a central support and a pair of beams extending in a reversed angled fashion from an end of the central support, the beams terminating in configured edge profiles which facilitate mounting of the anchor portions within apertures defined in the vehicle panel.

The vehicle panel further includes a cowl panel configured with an exposed and width extending channel which is adapted for receiving the elongated seal in resistive engaging fashion. A pair of end supporting muckets are integrated into the cowl panel for providing interface support between the seating ends of the seal and the adjoining vehicle fenders.

The first portion can also include any of a thermoplastic elastomer, thermal plastic vulcanite, or ethylene propylene diene rubber material. The second portion can also include any of a filled or unfilled polypropylene, a thermoplastic olefin, or a more dense ethylene propylene diene rubber. In application, the elongated body is adapted to being incorporated into any of a hood to radiator, rocker, front grille, rear trunk, deck lid or lift gate application.

### BRIEF DESCRIPTION OF THE DRAWINGS

Reference will now be made to the attached drawings, when read in combination with the following detailed description, wherein like reference numerals refer to like parts throughout he several views, and in which:

FIG. 1 is an illustration of a tri-extruded elastomeric hood to cowl seal according to one non-limiting embodiment of the present invention;

FIG. 2 is an enlarged end perspective of the seal depicted in FIG. 1 and showing the closed polygonal shape exhibited by the TPV or other softer material, such as which can also exhibit a frictional coefficient reducing olefinic based slip coat applied there-over, and to which is additional coextruded a harder (filled or unfilled polypropylene) material component for resistively engaging within a channel defined in the vehicle cowl structure;

FIG. 3 is a further cutaway of the seal and which better depicts the cross sectional engagement profile of the more rigid engagement material;

FIG. 4 is an underside rotated perspective view of a cowl panel configured with an exposed and width extending channel adapted for receiving the seal of FIG. 1, a pair of end supporting muckets being integrated into the cowl panel for providing interface support between the seating ends of the seal and the adjoining vehicle fenders;

FIG. 5 is an enlarged partial end view illustration of a selected mucket engaged to the cowl panel;

FIG. 6 is an inverted view of the cowl panel and mucket depicted in FIG. 5;

FIG. 7 is a perspective view similar to that shown in FIG. 4 and which illustrates the seal of FIG. 1 in installed fashion;

FIG. 8 is an enlarged partial end view illustration of a selected mucket engaged to the cowl panel and in cooperation with the snap-engagement of the tri-extruded seal shown in substantial transparency; and

FIG. 9 is an inverted view of the cowl panel and mucket depicted in FIG. 8 and illustrating the underside engagement of the resisting fitting and projecting portions integrated into the harder material into the track receiving features of the cowl panel.

### DETAILED DESCRIPTION OF THE PREFERRED EMBODIMENTS

As previously described, a coextruded or tri-extruded bulb seal is provided and which is constructed of at least one softer and one harder polymer material for various in-vehicle applications. These can include, without limitation, such seals being integrated along extending edge interfaces associated with the cowl to hood, rocker seal, grill seal, rear trunk and deck lid seals, lift gate seal, etc. Among other advantages, the seal eliminates the need for a secondary molded attachment pin, as it is integrated into the part.

One non-limiting depicted variant of cowl to hood seal provides a tri-extruded article, including a base attaching material exhibiting a more rigid filled or unfilled polypropylene, a polygonal and interiorly hollowed softer thermoplastic olefin, thermal plastic vulcanite, ethylene propylene diene monomer or the like, and an olefinic based slip coat which is coated or otherwise post applied and cured about the part and which provides a lowered coefficient of friction, such as during installation of the anchoring base material into a slot or channel associated with the mounting location. One non-limiting application of the tri-extruded seal located between the cowl and glass also depicts the use of a snap-in assembly with overlap, this including integrated end muckets which conform to an edge profile of the vehicle fender.

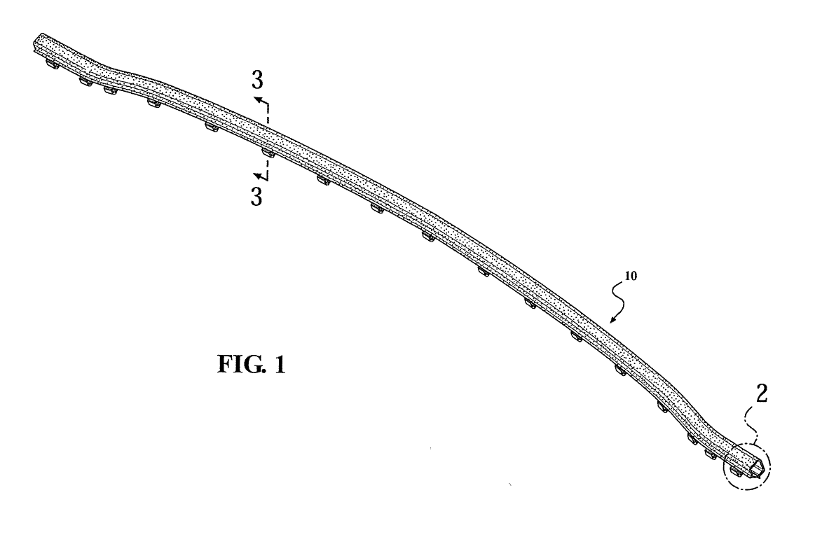

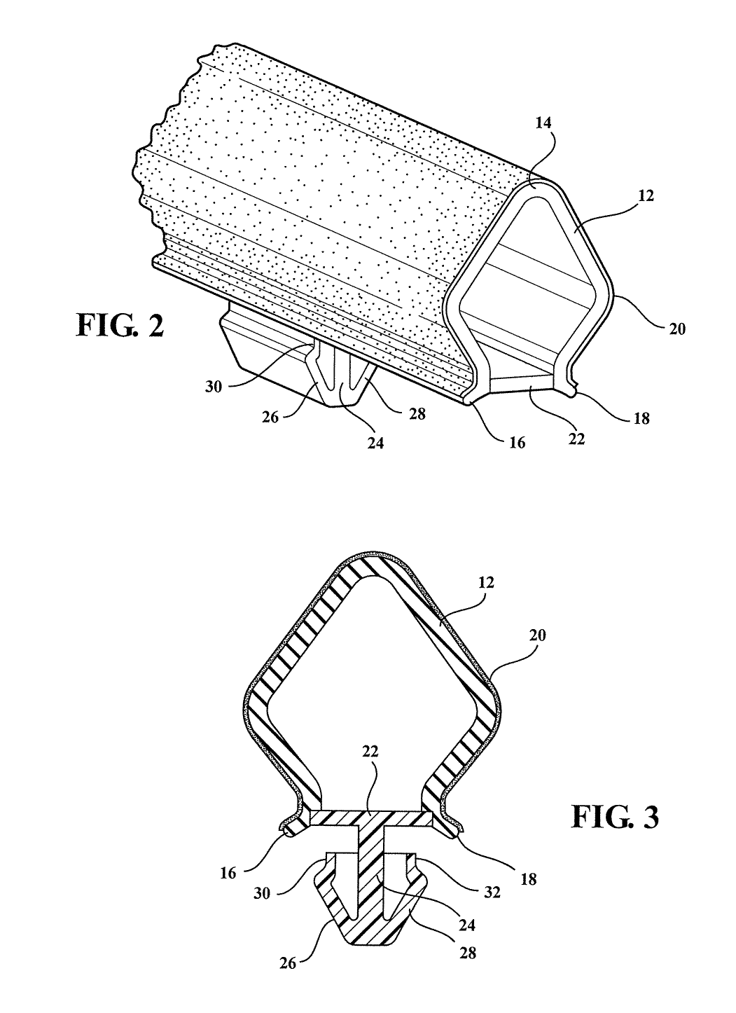

Referring now to the illustrations, FIG. 1 generally illustrates at 10 a tri-extruded elastomeric hood to cowl seal according to one non-limiting embodiment of the present invention. As further referenced in each of enlarged end perspective of FIG. 2 and further cutaway of FIG. 3, an upper bulbous shaped portion 12 is provided of a softer material and which can include any suitable elastomeric alloy such as a thermoplastic elastomer (TPE) or thermal plastic vulcanite (TPV), ethylene propylene diene rubber (EPDM) or other softer material.

The upper portion 12 as shown exhibits, according to one non-limiting example, a multi-sided (pseudo rectangular) profile in cross section with curved perimeter defining edges and which collectively defines a hollow interior, this in order to facilitate controlled and cushioning collapse of the upper portion 12 such as when compressed by an opposing inner rear surface of a vehicle hood or other moveable or stationary component associated with the vehicle (not shown). As further shown, the upper portion 12 exhibits a generally conical pointed upper end 14 and a pair of outwardly flared lower ends 16 and 18. A slipcoat 20 can be coated over the upper portion 12 and can include any type of plastic olefinic based grade or post applied and cured material, such as which reduces a coefficient of friction of the material in use among other advantages.

Co-extruded with the softer upper portion 12 is a harder/more rigid and elongated base material, this including an upper most planar mounting ledge 22 exhibiting a given width with opposite extending edges, along which the spaced lower ends 16 and 18 of the upper softer material 12 are engaged during the co-extrusion process (as best shown in the enlarged end view of FIG. 2). Referring again to FIGS. 2-3, the base material further includes a plurality of spaced apart and integrally projecting anchor portions which each include a central support 24, and with a pair 26 and 28 of reverse and angled beams extending from an extending end of the central support 24, the beams terminating in configured (uppermost and non-linear outer edge defining) profiles 30 and 32 which facilitate mounting of the anchor portions within associated seating structure of the cowl or other supporting location to which the base material is secured in a fashion which permits the softer upper material 12 to project upwardly in a manner to be engaged by the vehicle hood, trunk or the like.

The base material and associated anchor portion can further be constructed of a filled or unfilled polypropylene (PP), a thermoplastic olefin (TPO), a more dense EPDM material or the like. As with the upper portion 12, the base material and anchor portion can further exhibit an overlay application of the slip coat 20 or other suitable material in order to enhance its operating properties.

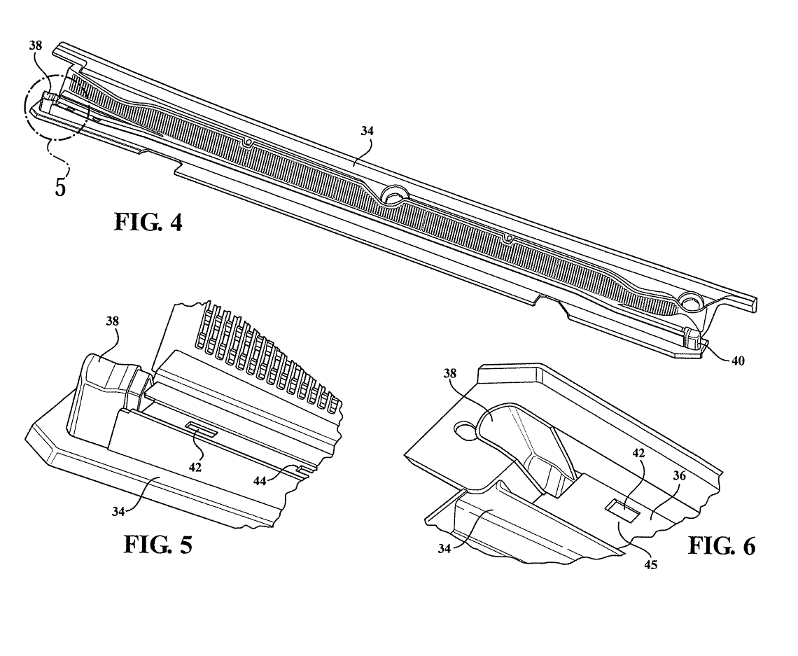

FIG. 4 is an underside rotated perspective view of a cowl panel 34 configured with an exposed and width extending channel, see recessed surface 36, and which is adapted for receiving the seal 10 of FIG. 1. A pair of end supporting muckets (see at 38 and 40 in FIG. 4 with selected mucket 38 further depicted in enlarged fashion in FIGS. 5-6), are provided and are integrated into the cowl panel 34 for providing interface support between the seating ends of the seal 10 and the adjoining vehicle fenders (not shown).

Further best shown in FIGS. 5 and 6 are a series of spaced apart and rectangular shaped apertures, referenced by inner perimeter surfaces 42 and 44 defined in a planar base surface 45 of the cowl panel 34, these being dimensioned to resistively seat and restrain each of the plurality of spaced apart anchor portions (see as further best shown in FIG. 9) in the manner shown. The seal 10 is then installed within the track profile of the cowl panel 34 (or other suitably configured vehicle panel), this as further depicted in FIG. 9 and without the requirement of secondary molded attachment pins or other fasteners.

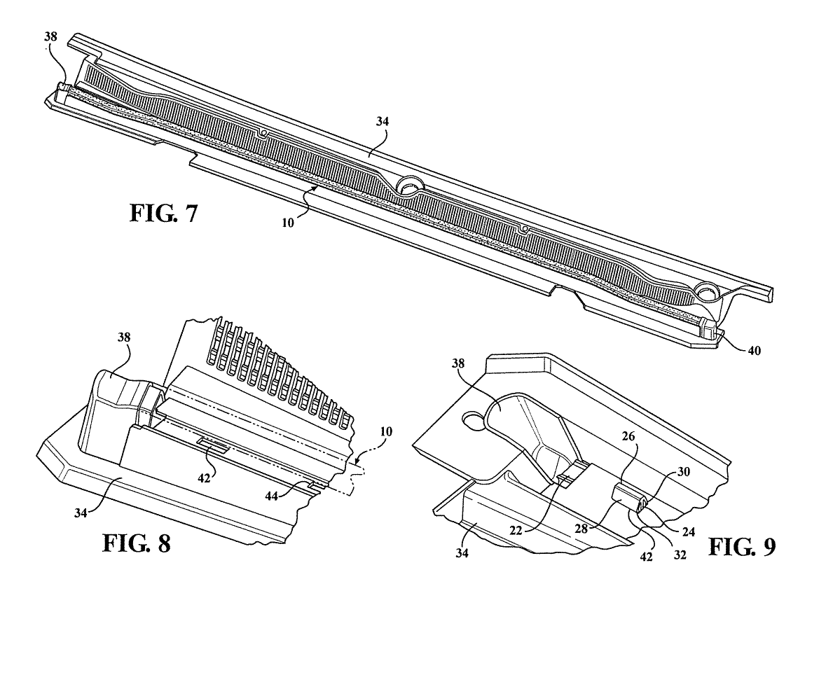

The succeeding environmental perspective of FIG. 7 depicts the elongated seal 10 installed within the cowl structure and so that the upper softer portion 12 projects in a fashion so that it can be contacted by the inner edge proximate surface of the vehicle hood. FIG. 8 is an enlarged partial end view illustration of selected mucket 38 engaged to the cowl panel 34 and in cooperation with the snap-engagement of the tri-extruded seal 10, which in this illustration is shown in substantial transparency.

As further described, the seal can be reconfigured for installation into any of hood to radiator, rocker, front grille, rear trunk, deck lid or lift gate applications. Yet additional variants of the invention further envisioned the seal being reconfigured as a wiper or lip seal or other bulb-type seal having any desired form or shape and which is coextruded or tri-extruded in the manner previously described in order to be installed into a suitable panel or supporting structure.

Having described my invention, other and additional preferred embodiments will become apparent to those skilled in the art to which it pertains, and without deviating from the scope of the appended claims.

I claim:

1. A seal assembly for incorporation into a vehicle, comprising:
an elongated panel having a length extending mounting surface, a plurality of spaced apart apertures formed in said mounting surface;
a seal having an elongated body including a first portion with a multi-sided and enclosed cross sectional profile terminating in a pair of outwardly spaced lower ends;
said body further including a second portion more rigid than said first portion and coextruded with said first portion, said second portion further having an elongated base material which includes an upper most planar shaped mounting ledge exhibiting a width with opposite edges to which inside opposing surfaces of said first portion are co-extruded;
said second portion further including a plurality of spaced apart anchor portions resistively engaged within said apertures formed in said panel mounting surface, said anchor portions including a central support projecting downwardly from said planar mounting ledge from which extends in a reverse and upwardly and outwardly angled fashion a pair of beams, said beams terminating in recess configured profiles which facilitate mounting of said anchor portions against inside perimeter extending surfaces associate with each of said spaced apart apertures defined in the vehicle panel and so that a lower surface of the panel abuts end faces of said beams located proximate said recess configured profiles, an upper surface of the panel contacting an underside of said mounting ledge and deflecting end-most locations of said lower ends.

2. The seal as described in claim 21, said multi-sided profile further comprising in cross section a hollow interior to facilitate controlled and cushioning collapse when compressed by the further component.

3. The seal as described in claim 21, further comprising a plastic slip coat applied over said elongated body.

4. The seal as described in claim 21, a pair of end supporting muckets being integrated into the cowl panel for providing interface support between said seal and adjoining fenders which are mounted to the vehicle.

5. The seal as described in claim 21, said first portion having a specified shape and size and further consisting of any of a thermoplastic elastomer, thermal plastic vulcanite, or ethylene propylene diene rubber.

6. The seal as described in claim 21, said second portion having a specified shape and size and further consisting of any of a filled or unfilled polypropylene, a thermoplastic olefin, or a more dense ethylene propylene diene rubber.
